(19) United States
(12) Patent Application Publication
(10) Pub. No.: US 2026/0227953 A1
(43) Pub. Date: Aug. 6, 2026

(54) Method and System for Multiverse Audio Experiences in Immersive Audio Formats

(71) Applicant: Tori La Rosa, Sherman Oaks, CA (US)

(72) Inventor: Tori La Rosa, Sherman Oaks, CA (US)

(21) Appl. No.: 19/349,992

(22) Filed: Oct. 4, 2025

Related U.S. Application Data
(60) Provisional application No. 63/728,330, filed on Dec. 5, 2024.

(51) Int. Cl. G06F 3/16; G10L 19/008; H04S 7/00

(52) U.S. Cl. CPC G06F 3/165; G10L 19/008; H04S 7/30

(57) ABSTRACT

This invention provides a method and system for creating multiverse audio experiences in immersive audio formats, including Dolby Atmos, binaural headphone rendering, and future equivalents. The method encodes alternate recorded versions of specific musical components alongside fixed stems, enabling multiple distinct performances of a composition to be delivered under a single release identity. Playback systems are configured to select between versions automatically based on platform capabilities or immersive audio settings, providing listeners with differentiated interpretations of the same musical work.

### TECHNICAL FIELD

The present invention relates to digital music production and distribution systems. More specifically, it concerns methods and systems for delivering multiple unique recorded versions of the same musical work within a single release, whereby listeners experience distinct performances depending on playback format, platform capability, or immersive audio rendering settings.

### BACKGROUND

Conventional music distribution platforms deliver a single fixed audio recording per release, identified by a unique ISRC or metadata entry. Even in immersive audio systems such as Dolby Atmos, playback typically involves only a re-mix or re-rendering of the same underlying performance. The listener's experience may vary based on device or decoding environment, but the source recording remains singular.

There has been no system in which multiple distinct recordings of the same song are bound to a single release identity, allowing listeners to encounter truly alternate performances while selecting the same song entry across platforms or playback modes.

In current industry frameworks (including IFPI and DDEX standards), distinct mixes or arrangements of a musical work are normally required to receive separate ISRC codes and to be treated as independent releases for royalty accounting and cataloging. The disclosed invention departs from these standards by introducing a technical system in which alternate masters and performances are unified under a single release identity while remaining distinguishable internally via metadata, enabling automatic version switching without creating multiple public listings or identifiers.

### SUMMARY

The disclosed system creates a multiverse audio experience, in which a single released song (bearing a single ISRC or equivalent identity in distribution systems) provides listeners with parallel alternate recordings depending on the playback environment.

This approach differs from existing immersive formats by introducing entirely alternate rhythm sections, harmonic instruments, melodic instruments, vocals, or percussive elements, effectively giving the listener access to multiple versions of the same song without requiring multiple releases. In some implementations, alternate performances may be recorded without exposure to the baseline stereo version, relying only on shared stems and a click track. This ensures interpretations are perceptually independent of the baseline version, thereby making the differences between versions more pronounced and noticeable.

The invention thus introduces a technological improvement in digital music distribution, integrating metadata-driven playback logic with unified release identifiers to enable alternate masters to be selected automatically based on detected playback capabilities. This represents a technical enhancement to streaming platforms and playback systems by providing format-aware, environment-adaptive content delivery.

The result is a novel method of distribution that merges the concept of parallel universes with music consumption, redefining the relationship between immersive audio technology and artistic expression.

### BRIEF DESCRIPTION OF THE DRAWINGS

FIG. 1 illustrates a unified release identity system in which a single release identifier is associated with both a stereo master recording and an immersive master recording.

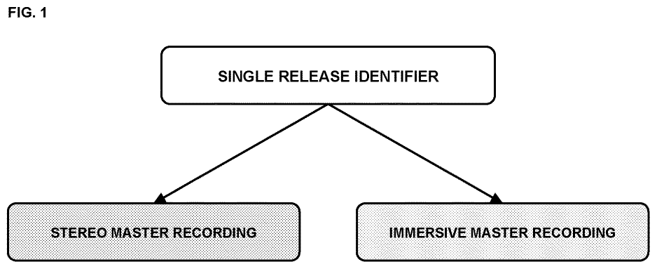

FIG. 2 illustrates a shared stem export process in which an engineer opens a digital audio workstation (DAW) session for the finalized stereo mix and exports separate stereo stems for selected groups of instruments in discrete passes. In individual passes, a single group of instruments may be exported from the finalized stereo mix.

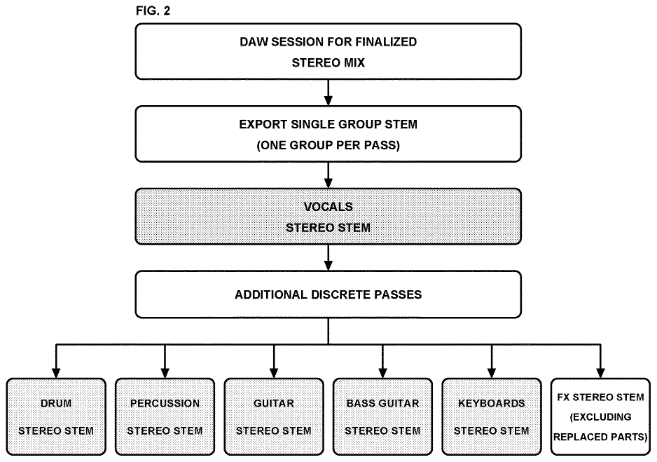

For example, one pass may export a vocals stereo stem, and additional passes may export drum stereo stems, percussion stereo stems, guitar stereo stems, bass guitar stereo stems, keyboard stereo stems, and other selected groups. A separate FX stereo stem may be exported in its own pass while excluding effects associated with parts designated for replacement in the immersive version.

FIG. 3 illustrates replacement parts for an immersive mix, including drums, bass, guitars, keyboards, and equivalent instruments that are recorded as alternate components and combined with shared stems, wherein levels of the replacement parts may be aligned with corresponding stereo stems to achieve consistent perceived loudness and balance.

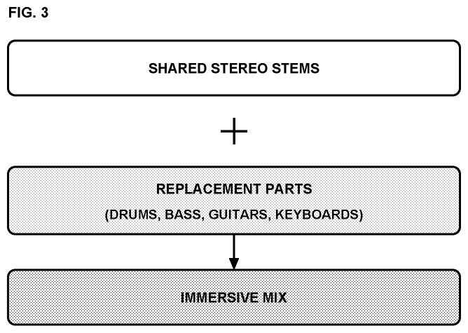

FIG. 4 illustrates a system-level workflow for producing alternate immersive mixes, including importing a stereo master, exporting shared stems, recording replacement parts, mixing, performing A/B comparisons, aligning levels, and distributing both stereo and immersive versions.

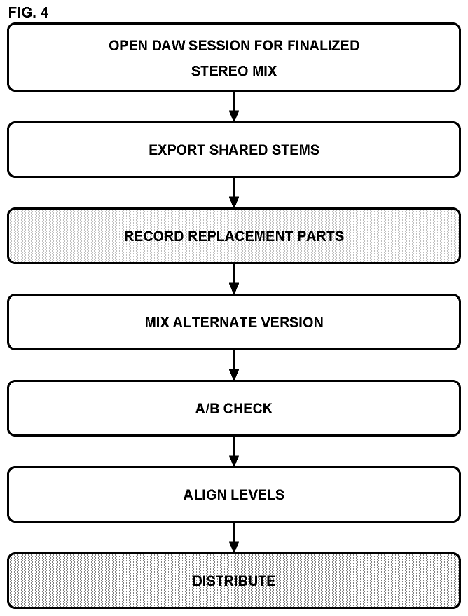

### DETAILED DESCRIPTION

### Unified Identity and Alternate Masters

In one embodiment, a single release of a musical work is associated with a unified identity in distribution systems (e.g., a single ISRC code or equivalent release identifier). Rather than distributing multiple separate releases for alternate recordings, the system binds multiple distinct masters to the same identifier.

The listener's playback device or streaming platform selects between these alternate masters based on playback mode and capability.

### For Example:

Standard Stereo Mode: The platform retrieves and plays back a primary stereo recording.
Immersive Mode: When playback is enabled on a device that supports Dolby Atmos, Apple's immersive audio technology, or other immersive rendering systems, the platform retrieves an alternate master recording that differs in instrumentation, rhythm section, or arrangement.
Cross-Platform Variance: Platforms with immersive audio support may access and present alternate versions, while platforms limited to stereo deliver the primary version.

Thus, the user selects the same song by name and identity. The variation arises not from user selection of a different product, but from the system's automatic mapping of playback mode to a designated alternate recording.

Playback Detection and Metadata Handling: In one implementation, the playback system or streaming platform determines the appropriate version to deliver by detecting the user's playback environment. The client application or device reports its capabilities (e.g., support for Dolby Atmos, Spatial Audio, or equivalent immersive rendering) to the platform's server, which then references metadata associated with the unified release identity. Each master file linked to the unified identifier contains a metadata flag specifying its intended playback context (e.g., stereo, immersive, or future formats).

Based on this flag and device capabilities, the platform automatically retrieves the correct version. The metadata structure can include a single public-facing ISRC code or equivalent release identifier while maintaining multiple internal asset identifiers for royalty tracking and archival management. This allows the listener to interact with one visible release entry while the system manages multiple versions in the background.

### Alignment and Level-Matching

In one implementation, the finalized stereo master is imported into Pro Tools and used as a fixed timing reference. Replacement rhythm parts (e.g., drums, bass, rhythm guitars, keyboards, or equivalent instruments) are recorded on new tracks locked to the stereo timeline.

During editing, alignment is verified so that replacement parts remain sample-accurate with the stereo master. During mixing, the alternate immersive version is A/B-checked against the stereo master at matched loudness, with adjustments ensuring consistent balances and dynamics while meeting immersive protocol requirements.

### Shared Stem Export Process

To ensure accuracy and continuity between stereo and immersive versions, each shared stem (e.g., vocals, piano, harmonic instrument, keyboards, woodwinds, brass, selected guitars, or equivalents) is exported individually from the finalized stereo mix with strict isolation.

By exporting directly from the mastered stereo mix, all shared stems preserve the exact balance, timing, and processing of the stereo baseline.

A dedicated FX stem may also be created, containing only reverbs, delays, and other effects applied to shared instruments, while excluding those applied to replaced rhythm instruments to avoid leakage or timbral conflict.

### Optional Techniques

Performance Isolation: Musicians recording alternate rhythm or instrumental parts may receive only shared stems and a click track, without access to the original stereo mix, ensuring independent interpretation.

Enhanced Perceptual Contrast: As a result of performance isolation, immersive alternate mixes exhibit heightened divergence from the stereo baseline, producing a pronounced perceptual contrast when switching playback modes or platforms.

### Optional Embodiment—Perceived Multi-Album Experience

In certain implementations, the method produces not only alternate interpretations of individual songs but also an effect comparable to a separate album within the same release identity. The immersive version can diverge so substantially from the stereo version that listeners perceive a second album accessible through immersive playback.

### Example—“Beautiful”

The song Beautiful exists in two distinct versions:
Stereo Mix (4/4, jazzy feel):
Drums—John Watson
Bass—Pasquale Monea
Guitars—Shane O'Mara & Tori La Rosa
Immersive Mix (2/4, soulful pop feel):
Drums—Gregg Bissonette
Bass—Chris Chaney
Guitars—Randy Jacobs

Shared across both versions are:
Vocals—Michael Paynter
Keyboards—Jamie Muhoberac
Piano—John McAll
Woodwinds—Tony Hicks
Clarinet—Alex Budman On non-immersive platforms, listeners hear the stereo version by default. On immersive-enabled platforms, the immersive version plays unless immersive playback is disabled.

Definitions:
As used herein:
“Perceptually distinct” means that the alternate versions of a composition have clearly distinguishable audible characteristics resulting from different recorded performances, instrumentations, or arrangements, rather than merely differing in mixing or encoding format.
“Format-agnostic metadata” refers to metadata structures designed to identify and associate alternate versions of a work independently of any specific immersive or stereo format, allowing compatibility with present and future rendering standards.

1. A method for producing a multiverse audio experience, comprising:
(a) encoding fixed musical components as a consistent baseline;
(b) encoding one or more alternate component layers performed by different musicians or arranged differently as synchronized alternates;
(c) maintaining timing and song identity across fixed and alternate components through shared stems and synchronization references; and
(d) enabling a playback system or streaming platform to automatically deliver alternate interpretations of the same song identity under varying playback conditions based on detected device capabilities or playback settings.

2. The method of claim 1, wherein alternate component layers are dynamically rendered, substituted, or layered depending on:
(a) whether playback is stereo or immersive;
(b) whether immersive rendering is enabled or disabled on the playback device; or
(c) whether playback occurs on current or future immersive formats including Dolby Atmos, Apple Spatial Audio, or equivalent immersive rendering technologies.

3. The method of claim 1, wherein the alternate components comprise substitutions of rhythm, harmonic, vocal, or percussive elements, optionally recorded without reference to the baseline stereo mix and using only shared stems and a click track, thereby producing versions that are perceptually distinct from the baseline.

4. The method of claim 1, wherein playback on headphone-based immersive systems delivers binaural rendering preserving depth and height, while playback on non-immersive systems renders a consistent baseline mix maintaining synchronization.

5. The method of claim 1, wherein the alternate layers are encoded with format-agnostic metadata identifying each version's intended playback context, ensuring compatibility with present and future immersive playback systems and rendering engines.

6. A system comprising a digital distribution platform configured to:
(a) associate multiple alternate masters of the same musical work with a single public release identifier;
(b) maintain internal asset identifiers for alternate versions linked to the unified release;
(c) deliver a stereo recording to non-immersive devices;
(d) deliver an alternate immersive recording to immersive-capable devices; and
(e) ensure all versions remain synchronized in timing, metadata, and release identity.

7. The method of claim 1, wherein alternate musical components are recorded without reference to the baseline stereo master, using only shared stems and a click track, thereby ensuring independent performances and perceptual distinctness between versions.

8. The method of claim 1, wherein cumulative alternate substitutions across multiple tracks of an album produce an immersive version perceptually distinct from its stereo counterpart, thereby providing listeners the experience of accessing a second album within the same release identity.
